(19) United States
(12) Patent Application Publication
(10) Pub. No.: US 2002/0152425 A1
(43) Pub. Date: Oct. 17, 2002

(54) Distributed restart in a multiple processor system

(76) Inventors: David Chaiken, Menlo Park, CA (US); Mark J. Foster, Palo Alto, CA (US)

Correspondence Address: GLENN PATENT GROUP, 3475 EDISON WAY, SUITE L, MENLO PARK, CA, 94025, US

(21) Appl. No.: 09/834,524

(22) Filed: Apr. 12, 2001

(51) Int. Cl. G06F 11/00

(52) U.S. Cl. 714/23

(57) ABSTRACT

Software or hardware on one node or processor in a system with multiple processors or nodes performs a cold or a warm restart on one or more other processors. Fault tolerance mechanisms are provided in a computing architecture to allow it to continue functioning when individual components, such as chips, printed circuit boards, network links, fans, or power supplies fail. One aspect of the invention provides multiple processors having self-contained operating systems. Each processor preferably comprises any of redundant network links; redundant power supplies; redundant links to input/output devices; and software fault detection, adaptation, and recovery algorithms. Once a processor in the system has failed, the system attempts to recover from the failure by restarting a failed processor. Because the preferred system is constructed as a set of self-contained processing units, it is possible to restart the system at a number of granularities, e.g. a chip, a printed circuit board (node), a subset of processors, or an entire engine. Each of these restarts can be any of a cold, warm, and/or software restart, and can be invoked by any of hardware, e.g. by a watchdog timer, software, e.g. by fault recovery algorithms, or by a human operator.

### BACKGROUND OF THE INVENTION

1. Technical Field

The invention relates to restarting a computer system after a system failure. More particularly, the invention relates to a mechanism for distributed restart in a multiple processor computer system.

2. Description of the Prior Art

Transient failures in computing systems result from component level hardware or software failures. It is often the case that a system can recover from such failures. Recovering from a failure might require toggling the power supply, i.e. a cold restart, toggling a reset signal, i.e. a warm restart, or terminating and rebooting system software, i.e. a software restart.

There are many well known techniques for automatically restarting computer systems, including hardware watchdogs, software power-down and reset mechanisms, and physical switches. Smart, uninterruptible power supplies are also know that have the capability for remote control of computer system power.

None of the known restart mechanisms provide for intelligent intercession by an operating node in a multiprocessor system. It would be advantageous to allow software or hardware on one node in a system with multiple processors to perform a cold or a warm restart on another processor.

### SUMMARY OF THE INVENTION

The invention provides a technique that allows software or hardware on one node or processor in a system with multiple processors or nodes to perform a cold or a warm restart on one or more other processors or nodes.

In the presently preferred embodiment of the invention, fault tolerance mechanisms are provided in a computer architecture to allow it to continue functioning when individual components, such as chips, printed circuit boards, network links, fans, or power supplies fail.

One aspect of the invention provides multiple processors having self-contained operating systems. Each processor preferably comprises any of redundant network links; redundant power supplies; redundant links to input/output devices; and software fault detection, adaptation, and recovery algorithms. Once a processor in the system has failed, the system attempts to recover from the failure by restarting the failed processor. Because the preferred system is constructed as a set of self-contained processing units, it is possible to restart the system at a number of granularities, e.g. a chip, a printed circuit board (node), a subset of processors (PLEX), or an entire architecture. Each of these restarts can be any of a cold, warm, and/or software restart, and can be invoked by any of hardware, e.g. by a watchdog timer, software, e.g. by fault recovery algorithms, or by a human operator.

### BRIEF DESCRIPTION OF THE DRAWINGS

FIG. 1 is a block schematic diagram that shows the implementation of a distributed restart in a multiprocessor system for processors within an individual system according to the invention;

FIG. 2 is a block schematic diagram that shows a distributed restart mechanism in accordance with the invention;

FIG. 3 is a block schematic diagram that shows the implementation of a distributed restart in a multiprocessor system for nodes within an architecture according to the invention; and

FIGS. 4a and 4b comprise a block schematic diagrams that show the implementation of a distributed restart in a multiprocessor system for processors contained within nodes that are arranged within a backplane according to the invention

### DETAILED DESCRIPTION OF THE INVENTION

A multiprocessor computing architecture, such as the AgileTV engine developed by AgileTV of Menlo Park, Calif. (see, for example, [inventor, title], U.S. patent application Ser. No. ______, filed ______, attorney docket no. AGLE0003, is a computing architecture comprised of multiple processors. Such multiprocessor computing architecture is designed to continue operation when individual components suffer hardware or software failures.

In the presently preferred embodiment of the invention, the following fault tolerance mechanisms are provided in the computer architecture to allow it to continue functioning when individual components, such as chips, printed circuit boards, network links, fans, or power supplies fail. Thus, one aspect of the invention provides multiple processors having self-contained operating systems.

Each processor preferably comprises:

Redundant network links;

Redundant power supplies;

Redundant links to input/output devices; and

Software fault detection (for example, a ‘ping’ and corresponding application level diagnostics), adaptation (for example, rerouting in the network and reassigning tasks), and recovery algorithms (for example, replicating job, i.e. software, state so that jobs can be restarted on correctly functioning processors or restarting failed processors or nodes).

While the invention is described herein in terms of a presently preferred embodiment, i.e. a multiprocessor, fault tolerant computer architecture, those skilled in the art will appreciate that the invention is readily applied to other system architectures and that the system described herein is provided only for purposes of example and not to limit the scope of the invention.

Once a processor in the system has failed, it is important to attempt to recover from the failure by restarting the failed processor. Because the preferred system is constructed as a set of self-contained processing units, it is possible to restart the system at a number of granularities, e.g. a chip, a printed circuit board (node), a subset of processors (PLEX), or an entire architecture. Each of these restarts can be any of a cold, warm, and/or software restart, and can be invoked by any of hardware, e.g. by a watchdog timer. Watchdog timers are known to those skilled in the art, for example, Watchdog timers can be used to detect the liveness of the system and will cause a full system reset if software does not prove its correct operation by regularly resetting the timer. Software, e.g. by fault recovery algorithms (discussed above) or by a human operator.

Thus, the variety of alternatives for restarting a failed processor provides considerable flexibility in applying restart strategies that are characterized by the type of restart (cold, warm, software), the granularity of restart (chip, node, PLEX, engine), and the source of the restart (software, hardware, human).

For example, connecting a reset signal from each node to one or more other nodes permits fault recovery software to warm restart one or more failed nodes. This distributed restart technique eliminates the need for human intervention after the occurrence of any of many types of software and hardware faults, such as livelock in the operating system scheduler, failure at one or more communication links, transistor-level lockup in the processor, or failure of software reset.

Connecting a power supply enable signal to one node from another allows system software at a node to cold restart another node (e.g. turn the power supply of the failed processor off and back on), thereby allowing recovery from classes of failures not covered by a warm restart, such as transistor-level lockup in the processor, errors in state machines in the processor. Such control over the power supply also allows selective node shutdown of processors or nodes, which can be used to adapt to elevated temperature conditions (see, for example, [inventor, title], U.S. patent application Ser. No. _______, filed ______, attorney docket no. AGLE0023.

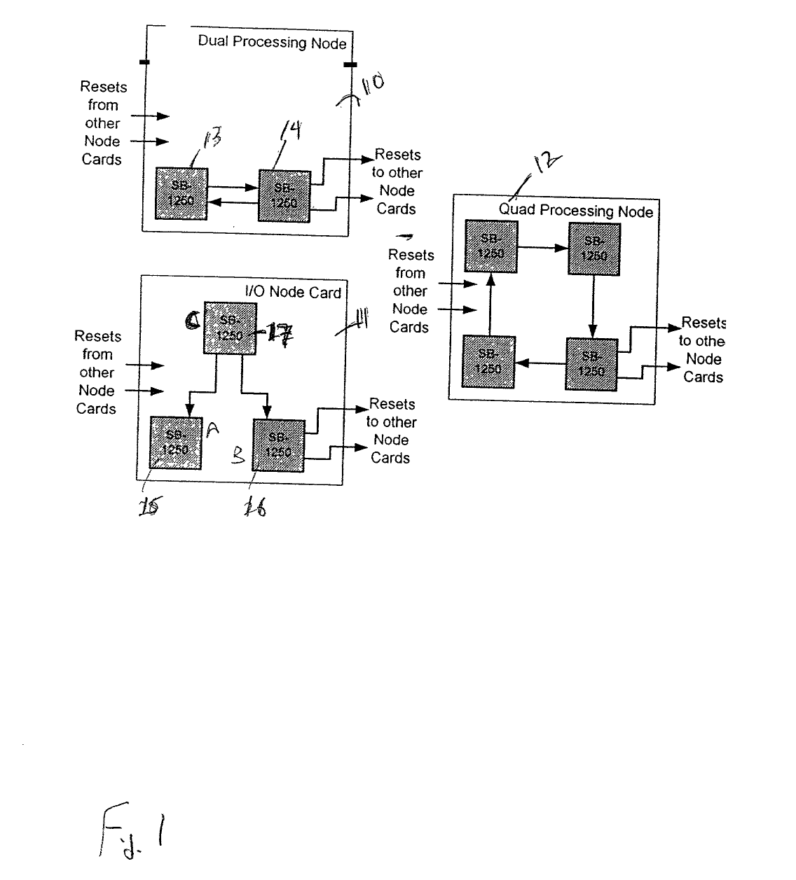

FIG. 1 is a block schematic diagram that shows the implementation of a distributed restart in a multiprocessor system for processors within an individual system according to the invention.

The embodiment of the invention that is shown in FIG. 1 is a system comprised of one or more nodes 10, 11, 12 having multiple processing units, e.g. dual processing node comprises two processors 13, 14. Each of these processing units is responsible for some part of the functioning of the system.

The processing units are interconnected by a network, such as Ethernet. Each processing unit is preferably assigned a task within the system, such as controlling disks or communicating with another network. For purposes of the discussion herein, a network can include bi-directional, i.e. FIFO, interfaces.

In the preferred embodiment of the invention, the processors can talk to each other. With regard to FIG. 1, consider the three processors: processor A 20, processor B 21, and processor C 22. Processor A is connected, for example, to a disk (not shown), processor B could also be connected to the disk, and processors A, B, and C are configured to communicate with each other. For purposes of the discussion herein, such arrangement is referred to as a fault-tolerant configuration. Thus, if processor A fails, i.e. it suffers either a hardware fault or a software fault, then processor B can assume its functions. From the perspective of a user in the external world, such a failure goes unnoticed by the user and is of no great concern to the user as long as there is enough aggregate performance in the system that the user does not notice the failure. Thus, the preferred embodiment of the invention is especially well suited for multiple processor systems that provide redundancy for fault tolerance.

However, in such system if processor A fails and does not restart, and then processor B also fails, resulting system performance degradation is likely to be noticed by, and objectionable to, a user. This is of particular concern in a consumer installation, such as a Web server, telecommunications system, or cable television application, where degradation in performance of the system results in diminished user satisfaction, i.e. loss of sales.

A key aspect of the invention herein is the ability for one processor, e.g. processor B to reset another processor, e.g. processor A, i.e. to say “start yourself from scratch.” As discussed above, the invention provides a number of different ways to do that. For example, with regard to the power supply that is supplying power to processor A, it is possible to turn that power supply off and then turn the power supply back on to reboot the processor.

In the presently preferred embodiment of the invention, it is contemplated that the multiprocessor system incorporates two or more processing units that are running the same operating system. Thus, a failure in one processor is likely to eventually occur in another processor. In this embodiment of the invention, the ability to get back to an initial condition is very important. One aspect of this embodiment of the invention provides that each processor includes internal circuits, e.g. chips, that have reset signals. In particular, each processor includes for the purposes of the discussion herein, a cold reset is a power-supply-level reset and a warm reset is a processor-level-reset. Reset lines provide different levels of reset.

In this embodiment, there is direct communication from one processor to another processor's reset line. For example, if two processors are on the same node or on the same card, and if both of these processors fail, then a third processor, e.g. processor C, could reset the whole card.

Thus, the invention is preferably comprised of a system that already has fault tolerance built in so that when one processor fails, a mechanism is invoked that allows that processor to recover from that failure, i.e. the fault tolerance is intended to allow continued operation in the event of a failure of one processor, but in the invention the fault tolerance is surprisingly used to provide an opportunity for an operating processor to reset a failed processor before additional processors can fail. Thus, software on a node that is operable can reset software on a node that has failed.

One presently preferred technique for restarting a failed processor works by toggling a signal. For example, processor B can toggle a signal on processor A. In an alternative and equally preferred embodiment, there is a unique power supply or power regulator for processor A, and there is a unique power supply for processor B. In the event of a failure in processor A, processor B could turn the power off for processor A and then turn the power back on, thereby effecting a cold restart of processor A.

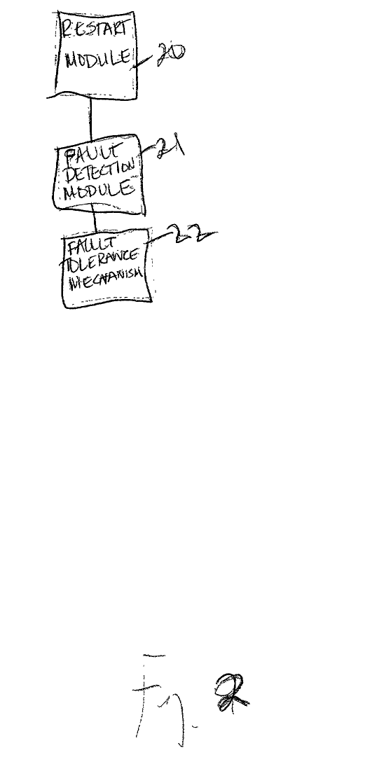

FIG. 2 is a block schematic diagram that shows a distributed restart mechanism in accordance with the invention. The fault tolerance mechanism 22 establishes a communicative interconnection between the processors or nodes within the architecture. A fault detection module 21 executes a fault detection strategy and, upon detection of a faulty processor or node, communicates with a restart module 20 to initiate a restart procedure, as discussed herein.

To operate, the system must first determine that a processor failure, in fact, has occurred. In the preferred embodiment, the system knows that there is a processor failure because the faulty processor, for example, has stopped responding to requests. Thus, one way to detect a failure is to provide a heartbeat in the system, such that the processors all talk to each other over time. Each processor pings each other processor in a predetermined way. If a processor does not return a ping, or alternatively, does not issue a ping, then a fault is reported for that processor by its corresponding processor(s). Such heartbeat mechanism may be implemented in any appropriate way, as is known in the art

Another method for detecting a processor failure is that of running application diagnostics. For example, in a speech recognition application, the system takes a known sample and feeds it into a processor that is running a speech recognition application. The diagnostic supplies a known input and determines if a correct result is returned by the processor, e.g. making sure that the right text comes for an input phrase, such as “Take me to your leader.” Thus, every processor in this embodiment has a diagnostic routine built in, which is typically a simple routine (as is known to those skilled in the art) that sends a string out, for example, or a piece of data out, and then looks for a sum to come back to show that the processor is operable and can therefore provide a correct response.

Each processor periodically runs this routine, as with a heartbeat, only it is an intelligent heartbeat. One important thing is that if a processor is primarily executing, for example, speech recognition it is very important that the processor use a diagnostic which is representative of the work that it is actually performing. In this way, it is possible to catch the vast majority of failures that are relevant to the specific task being performed by the processor. As another example, if the processor is a Web browser, the diagnostics sends it an HTTP stream and makes sure that the processor outputs the right data.

Another method for detecting a processor failure is the detection of excessive communication errors on any one link beyond some threshold, which indicates non-functionality of the processor. Those skilled in the art will appreciate that other methods of fault detection may be applied in connection with the operation and practice of the invention. For example, in an I/O processor, where the system is pinging a gateway, communications failures beyond a threshold are a good indication of processor failure.

For purpose of implementing the invention, it is important that the processors be able to talk to each other through a network. It does not matter what the network is—for purposes of the discussion herein, a network is some mechanism that allows the processors to communicate, i.e. they are communicatively coupled. Thus, a network could be a backplane, an Ethernet, a serial link, a token ring, or any other such arrangement. A key point is that the processors must be able to talk to each other and that every processor be aware of at least one other processor, and sometimes maybe even more processors, depending on how they are configured, so that processors can check with each other to determine proper operation of a corresponding processor(s).

Another important aspect of the invention is that of reset hierarchy. In a preferred system there are nodes which correspond to printed circuit boards, and each node has multiple processors on it, e.g. two or more in the presently preferred system. These nodes, or rather the printed circuit cards on which they reside, are plugged into a backplane.

If one chip on a node fails, then a functioning chip on a node may be able to reset the non-functioning chip, and vice versa (see, for example, the node 11 and corresponding processors 15, 16, 17 in FIG. 1). Communications are still active to one of the chips on the node, and the functioning processor can reset the faulty processor. However, in the event of a communications interruption, for example, on a bus lockup on the node card, all of the chips on that node card may fail. If all of the chips fail for some reason, then the invention provides the ability to reset effectively the entire node, such that a processor on one node can reset the other node.

In connection with this aspect of the invention, it is desirable not to use too many signals to implement this strategy, as well as not to introduce too many failure paths. Thus, an important design constraint is to reduce the number of faulty paths. For example, in an important I/O node where there is one processor that is a special purpose processor and two other processors that are more general purpose processors, the special purpose processor is more likely to have a connection to the outside world, and the two other processors only have connections within the node itself. In this situation, only the special purpose processor can reset the generic processors. If that special purpose processor fails, then it can be reset by a neighboring node. Thus, it is important to maintain a reset hierarchy in a way that does not propagate undue management options, i.e. by adding only the minimum number of new failure modes. One tradeoff to this approach is that an I/O node, for example, might fail locally and it could be reset locally, but it is deemed better to go up to the network in that case and get a peer to reset it, and in that way restrict access to the outside bus. Thus, at each level within the hierarchy there is preferably a master processor that is the subject of higher level fault correction, while the other processors in the node (or at this level) are reset by this processor.

In the invention, it is not necessarily true that every chip or every node must be able to reset every other node. In the preferred embodiment, each node can reset two other nodes and the resets are linked in a chain that goes through the system, which corresponds to the way that cards are plugged into the system. If one plugs in a basic four-card array, then all four processors are able to reset each other, and if more cards are plugged in then they are linked in a chain. Thus, at this level the notion of hierarchy may be less important as is the notion of extensibility. Both aspects of a system design are considered when determining the appropriate level of interprocessor communication and reset capability.

Finally, the invention provides a reporting mechanism or supervisor function, such that if there is a failure the failure is logged and reported. For example, if processor B resets processor A even once a day, then the system places a service call because processor A probably needs to be replaced.

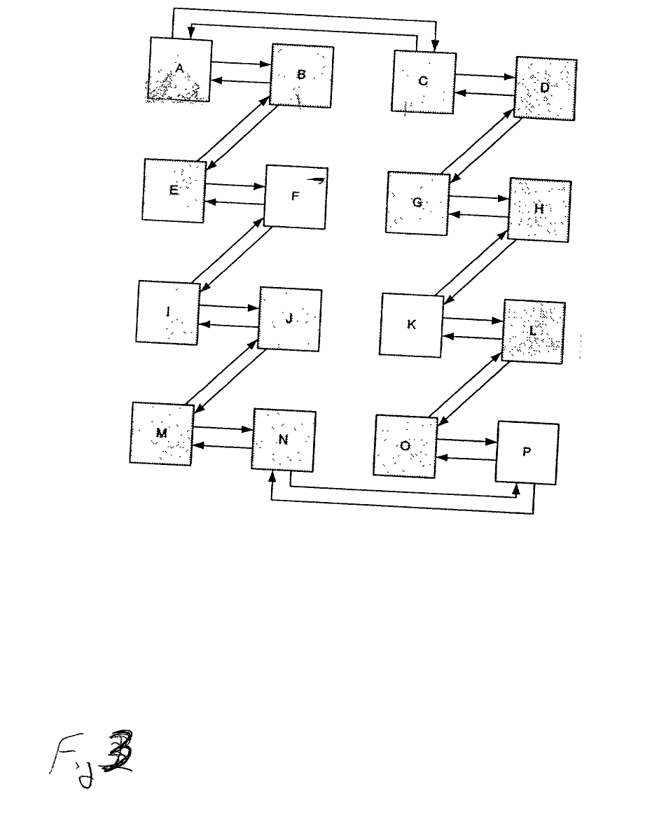

FIG. 3 is a block schematic diagram that shows the implementation of a distributed restart in a multiprocessor system for nodes A-P within an architecture according to the invention.

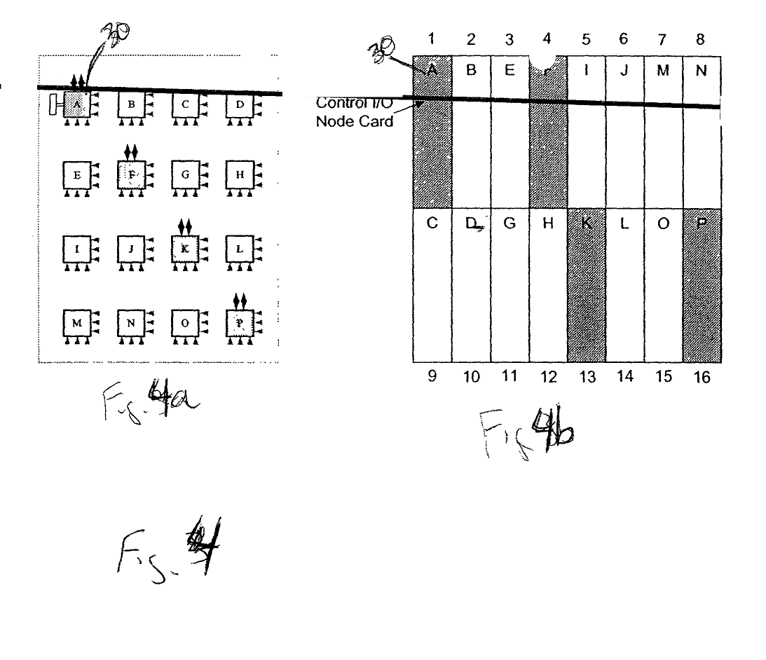

FIGS. 4a and 4b comprise a block schematic diagrams that show the implementation of a distributed restart in a multiprocessor system for processors contained within nodes that are arranged within a backplane according to the invention. FIG. 4a shows several nodes and, for example, a first node A 30, while FIG. 4b shows node A arranged in a backplane.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. An apparatus for restarting a failed processor or node, comprising:
a restart module associated with a node or processor in a system having multiple processors or nodes for performing any of a cold or a warm restart on one or more other processors or nodes; and
a fault detection module associated with said restart module for detecting failure of one or more of said other processors or nodes, wherein said restart module is invoked when a failure is detected by said fault detection module to restart said one or more other processors or nodes that have failed.

2. The apparatus of claim 1, wherein said system further comprises:
a fault tolerance mechanism for allowing said system to continue functioning when individual components of said system fail.

3. The apparatus of claim 1, wherein said system further comprises:
a multiple processor architecture in which each processor has a self-contained operating system.

4. The apparatus of claim 3, wherein each processor comprises any of redundant network links, redundant power supplies, redundant links to input/output devices, and software fault detection, adaptation, and recovery algorithms.

5. The apparatus of claim 1, wherein said restart module attempts to recover from a failure by restarting a failed system at any of a number of granularities which may comprise a chip, a printed circuit board (node), a subset of processors, or an entire processing system.

6. The apparatus of claim 1, wherein said restart module attempts to recover from a failure by any of a cold, warm, and/or software restart.

7. The apparatus of claim 1, wherein said restart module is invoked by any of hardware, software, or a human operator.

8. In a multiprocessor computing architecture comprised of multiple processors, an apparatus for restarting a failed component thereof, comprising:
a restart module associated with a node or processor in said architecture for performing any of a cold or a warm restart on one or more failed components;
a fault detection module associated with said restart module for detecting failure of one or more of said failed components, wherein said restart module is invoked when a failure is detected by said fault detection module to restart said one or more failed components; and
a fault tolerance mechanism for allowing said architecture to continue functioning when individual components thereof fail.

9. The apparatus of claim 8, wherein said fault tolerance mechanism comprises any of multiple processors having self-contained operating systems, redundant network links, redundant power supplies, redundant links to input/output devices, and software fault detection, adaptation, and recovery algorithms.

10. The apparatus of claim 8, wherein said restart module is adapted to restart a system at a number of granularities.

11. The apparatus of claim 10, wherein said restart module can perform any of a cold, warm, and/or software restart.

12. The apparatus of claim 10, wherein said restart module can be invoked by any of hardware, software, or a human operator.

13. The apparatus of claim 10, wherein said restart module comprises:
a distributed restart mechanism that eliminates a need for human intervention after occurrence of a software and/or hardware fault by connecting a reset signal of at least one node in said architecture to one or more other nodes therein;
wherein said distributed restart mechanism performs a warm restart of said one or more failed nodes.

14. The apparatus of claim 10, wherein said restart module comprises:
a distributed restart mechanism for connecting a power supply enable signal to a failed node in said architecture from another node therein;
wherein said distributed restart mechanism performs a cold restart of a failed node, thereby allowing recovery from classes of failures not covered by a warm restart.

15. The apparatus of claim 10, wherein said restart module comprises:
a distributed restart mechanism that allows one processor or node in said architecture to reset another processor or node therein.

16. The apparatus of claim 10, wherein said restart module comprises:
a distributed restart mechanism that allows one processor or node in said architecture to turn a failed processor or node's power supply off and then turn said power supply back on to reboot said processor or node.

17. The apparatus of claim 10, wherein each processor includes any of cold and warm reset lines which provide different levels of reset; and
wherein there is a direct communication from at least one processor to another processor's reset line.

18. An apparatus for allowing a component within a fault tolerant, multiprocessor system to recover from a failure, comprising:
a fault tolerance mechanism for allowing continued system operation in the event of a failure of one processor or node; and
said fault tolerance mechanism further comprising a fault recovery module for resetting a failed processor before additional processors can fail;
wherein a node that is operable can reset a node that has failed.

19. The apparatus of claim 18, further comprising:
a fault detection module for sending requests to processors or nodes within said system, wherein said fault detection module identifies a processor or node failure when a processor or node stops responding to said requests.

20. The apparatus of claim 19, said fault detection module comprising a heartbeat in said system, wherein each processor or node pings each other processor or node in a predetermined way, and wherein if a processor or node does not return a ping, or alternatively, does not issue a ping, then a fault is reported for that processor or node by a corresponding processor or node.

21. The apparatus of claim 19, said fault detection module comprising an application diagnostic routine within every processor or node that sends an application-level input out and then looks for an applications-level response to come back to show that the processor or node is operable and can therefore provide a correct response.

22. The apparatus of claim 21, wherein said application diagnostic routine is representative of work that said processor or node performs.

23. The apparatus of claim 19, said fault detection module comprising a mechanism for detecting excessive communication errors on any one link beyond a predetermined threshold, which indicates non-functionality of a processor or node associated with said link.

24. The apparatus of claim 18, said fault recovery module further comprising:
a reset hierarchy wherein, at each level within the hierarchy, there is preferably a master processor or node that is the subject of higher level fault correction, while other processors or nodes at this level are reset by said processor or node.

25. The apparatus of claim 18, further comprising:
any of a reporting mechanism and supervisor function, wherein if there is a failure said failure is logged and reported.

26. A method for restarting a failed processor or node, comprising the steps of:
providing a restart module associated with a node or processor in a system having multiple processors or nodes for performing any of a cold or a warm restart on one or more other processors or nodes; and
providing a fault detection module associated with said restart module for detecting failure of one or more of said other processors or nodes, wherein said restart module is invoked when a failure is detected by said fault detection module to restart said one or more other processors or nodes that have failed.

27. The method of claim 26, further comprising the step of:
providing a fault tolerance mechanism for allowing said system to continue functioning when individual components of said system fail.

28. In a multiprocessor computing architecture comprised of multiple processors, a method for restarting a failed component thereof, comprising the steps of:
performing any of a cold or a warm restart on one or more failed components;
detecting failure of one or more of said failed components, wherein said cold or a warm restart is invoked when a failure is detected to restart said one or more failed components; and
allowing said architecture to continue functioning when individual components thereof fail.

29. A method for allowing a component within a fault tolerant, multiprocessor system to recover from a failure, comprising the steps of:
allowing continued system operation in the event of a failure of one processor or node; and
resetting a failed processor before additional processors can fail;
wherein a node that is operable can reset a node that has failed.
